(19) United States
(12) Patent Application Publication
(10) Pub. No.: US 2012/0219285 A1
(43) Pub. Date: Aug. 30, 2012

(54) IN-BAND OPTICAL SIGNAL TO NOISE RATIO MONITORING TECHNIQUE

(76) Inventors: David Jimmy Dahan, Ramat-Gan (IL); Uri Mahlab, Or Yehuda (IL)

(21) Appl. No.: 13/398,969

(22) Filed: Feb. 17, 2012

(30) Foreign Application Priority Data
Feb. 28, 2011 (IL) 211451

(51) Int. Cl. H04B 10/08

(52) U.S. Cl. 398/26

(57) ABSTRACT

A monitor for monitoring OSNR of data being carried via an optical network link, the monitor obtains an optical signal from the link, comprises a loop of a non-linear optical medium capable of producing a back reflected signal to the optical signal and of looping the back reflected signal; and comprises a device for extracting a portion of the looped back reflected signal from said loop. The monitor further comprises a first photodetector for measuring power of the optical signal and a second photodetector for measuring power of the extracted portion of the looped signal. Finally, there is a processing unit for determining OSNR of the optical signal based at least on readings of the first and the second photodetectors.

### CROSS-REFERENCE TO RELATED APPLICATIONS

This application claims priority of Israel Patent Application No. 211451, filed Feb. 28, 2011, the disclosure of which is incorporated by reference herein in its entirety.

### FIELD OF THE INVENTION

The present invention relates to technology for in band Optical Signal to Noise Ratio (OSNR) monitoring of optical networks, based on so-called laser signal generation using Stimulated Brillouin Scattering (SBS) or Stimulated Raman Scattering (SRS), and especially to technology enabling such performance monitoring in modern high speed (high bit rate) systems.

### BACKGROUND OF THE INVENTION

Deployment of high speed transparent and reconfigurable optical networks requires effective flexible and robust Optical Performance Monitoring (OPM) techniques for ensuring high quality of service. The modern high speed networks are susceptible of optical signal degradations, mainly due to the Amplified Spontaneous Noise (ASE) from the optical amplifiers. Real time monitoring of the OSNR is a requirement in order to ensure the signal quality and in order to monitor potential failures in the transmission link.

The most common method to monitor the OSNR is based on the spectral analysis of the Transmission WDM signals and derives the OSNR by interpolating the out of band noise level into the signal band, namely by estimating the in-band noise level using the out of band noise level [D. C. Kilper, R. Bach, D. J. Blumental, D. Einstein, T. Landolsi, L. Olstar, M. Preiss and A. E Willner, “Optical performance monitoring,” J. Lightwave Technology, Vol. 22, no 1, pp. 294-304, 2004].

However such a technique suffers from the use of optical filtering and routing in the link path since the out of band noise must be filtered out and therefore the interpolating method leads to severe underestimates of the real OSNR level.

Methods to derive OSNR level by estimating the in band noise level directly, even in the presence of optical filters in the link, are referred as “In-Band OSNR” methods. In-band monitoring and measurement of OSNR means that the noise power is directly monitored/measured within the signal band in real time. An in-band OSNR method is a better approach than an interpolation OSNR method where the noise level within the signal band is estimated and interpolated using noise measurements out of the signal band.

Several In-Band OSNR methods have been proposed in prior art, for example in the reference mentioned above, in [G. Rossi, T. E Dimmick and D. J Blumenthal, “Optical performance monitoring in reconfigurable WDM optical networks using is subcarrier multiplexing”, J. Lightwave Technology, vol. 18, n12, pp 1639-1648, 2000], etc. The In-Band methods are based on various approaches such as electrical carrier to noise monitoring, polarization nulling, optical delay interferometer, nonlinear transfer functions using an optical parametric amplifier, a nonlinear loop mirror. Some of these methods are sensitive to other system impairments such as Chromatic Dispersion (CD) and Polarization Mode Dispersion (PMD) and this makes the OSNR monitoring more challenging. Relevant references are presented at the end of the description.

Methods of In-Band OSNR monitoring technique based on Stimulated Brillouin Scattering (SBS) effect, described in WO 2008151384 A1 and WO10150241A to ECI Telecom, have an advantage in that it is insensible to CD and PMD. The SBS effect [M. J. Damzem, V. Vlad, A Mocofanescu, V. Badin, “Stimulated Brillouin Scattering: Fundamentals and Applications”, Institute of Physics, Series in Optics and Optoelectronics (CRC Press, 2003)] is a spectral nonlinear effect which leads to the nonlinear power transfer from the signal spectral component to a Stokes wave (down shifted in frequency with respect to the signal frequency) propagating in the backward direction with respect to the signal. The OSNR technique based on the SBS effect uses the fact that when a signal has its higher spectral components above the SBS threshold, the efficiency of the power being transferred to the Stoke wave is altered by the noise present within the signal band.

The noise being present within an optical signal in a real optical system (such as an optical link) is the so-called Amplifier Spontaneous Emission (ASE) noise being introduced by optical amplifiers which form part of the optical link. FIG. 1 of the WO 2008151384 A1 is demonstrated as FIG. 1a (prior art) of the present patent application. FIG. 1a schematically illustrates the ASE noise, being always present within a real optical signal, as a noise source 22 which introduces a variable value of noise to a pure optical signal produced by an optical signal source 20. The resulting optical signal is then fed to an SBS based OSNR monitor 10.

WO 2008151384 further demonstrates results of the SBS based OSNR technique for 40 Gbps NRZ (Non return to Zero) OOK (On-Off Keying) signal, which presents dynamic OSNR monitoring range of 15 dB for OSNR from 15 to 30 dB. Quite high sensitivity (15 dB) is demonstrated due to the fact that the 40 Gbps NRZ OOK signal spectrum presents a prominent spectral peak at the carrier wavelength which is sufficiently narrow to stimulate an efficient SBS effect. The efficiency is also enhanced by the fact that the inventors of WO 2008/151384 use a broadband bandpass filter (1 nm bandwidth) which, however, is not compliant with operations with 100 GHz and 50 Ghz channel spacing. Moreover, the NRZ OOK modulation format presents severe system penalties for bit rates of 40 to 100 Gbps; Phase modulation formats (optionally combined with amplitude modulation formats) are preferred and are optionally combined with polarization multiplexing scheme for additional CD and PMD impairment relaxations. Furthermore, with the network operating at 40 and 100 Gbps, and with utilizing the modulation formats such as DPSK (Differential phase shift keying), DQPSK (Differential Quaternary Phase Shift Keying) and DP-QPSK (Dual Polarization Quaternary Phase Shift Keying), OSNR requirements become stronger and the network links should be planned to meet OSNR of 15 dB and higher at the link end.

A real optical system such as a network link or the like, in order to be practically useful for carrying high bit rate optical signals, must have OSNR higher than 15dB (i.e., must have a low in-band ASE noise level). Therefore, the optical signal carried through such an optical link cannot cause a significant change in the SBS induced reflected power. Due to that, the OSNR monitoring sensitivity range of the apparatus described in WO 2008151384 A1 will be drastically limited when applied to real modern optical systems. It should be further noted that when the channel grid in such optical systems is limited to 50 GHz, the amount of in band noise should be even more reduced. It means that for the spacing of 50 GHz, the sensitivity of the WO 2008151384 apparatus becomes totally unacceptable.

However, WO 2008151384 describes a set-up for measuring/monitoring OSNR in real optical systems (FIG. 4), which is reproduced in the present application as FIG. 1B. The optical signal 42 comprising in band noise is transmitted via an optical network link 44 and is tapped from it to the SBS based OSNR monitor 10.

Upon analyzing the sensitivity of the real system set-up of WO 2008151384 A1, that set-up occurs to be:
a) ineffective (having low sensitivity) for monitoring signals with relatively high OSNR which is the condition for optical links at high bit rates (i.e., 40 Gbps and higher);
b) practically inapplicable for modulation formats other than NRZ OOK, which are more preferable than NRZ OOK for the high bit rates.

Therefore an OSNR monitoring technique is required, which would ensure a sufficient dynamic monitoring for OSNRs ranging from 15 to 30 dB.

A novel technique has been proposed by the Applicant (in WO10150241A to ECI Telecom) for in-band OSNR monitoring in optical network, compliant to very high speed modulation formats and with the ability to tune the OSNR sensitivity range.

Contrary to the prior art apparatus proposed in WO 2008151384, the technique of WO10150241A intentionally adds noise power to the signal to be monitored in order to enhance the change in the SBS back reflected power. The intentional noise additional leads to a significant increase in the OSNR monitoring sensitivity which is very crucial for high speed modulation formats at 10,40 and 100 Gbps. The apparatus to according to the ECI technique is compliant with several types of modulation formats and also supports polarization multiplexed signals. Knowing the Optical Power Composite to Noise ratio (OPcNR) and the effective OSNR of the altered signal (OSNR2), the mentioned apparatus enables obtaining a correct estimate of the original signal OSNR.

However, the SBS based in band OSNR monitoring apparatus, previously proposed by the Applicant, requires a long and expensive highly nonlinear fiber (HNLF) and a high power optical amplifier, since a high bit rate optical signal (for example the signal based on phase and Quadrature and Amplitude Modulation (QAM) optical modulation formats), presents a high SBS threshold. For example, 44.6 Gbps DQPSK and 126.5 Gbps DP-QPSK modulation formats require using 3 km long HNLF fiber with launched power of 23 dBm (or the launched power higher than 30 dBm, when using a 3 meter long Chalcogenide fiber) in order to be able to generate the back reflected power from the SBS effect. Such high cost components make the in- band OSNR monitoring SBS based approach less cost-attractive for network deployment.

### OBJECT AND SUMMARY OF THE INVENTION

It is an object of the present invention to propose a novel, relatively inexpensive technique for in band OSNR monitoring in optical network, compliant to very high bit rates and various modulation formats and with the ability to effectively increase and tune the OSNR sensitivity range.

The above object can be achieved by providing a technique that utilizes a known SBS or SRS effect in an optical medium, but enables providing efficient, low SBS/SRS threshold by modifying the OSNR monitoring equipment.

The lowered threshold should be understood in the following context. For obtaining any specific power of a back reflected Stokes signal caused by SRS or SBS effect, the Inventors have found a new way to apply an input optical signal which has much lower input power than in the prior art circuits.

According to a first aspect of the invention, there is provided an OSNR monitor for monitoring OSNR of data being carried via an optical network link, the monitor comprising:

means (such as a filter or a splitter) for obtaining an optical signal from said link;

a loop comprising a non-linear optical medium (say an optical fiber, a waveguide), being capable of producing a back reflected signal to said optical signal, the loop being adapted to loop said back reflected signal (so that only the back-propagated (back reflected) signal circulates in the loop);

a device (such as an optical splitter) for extracting a portion of the looped back reflected signal from said loop;

a first photodetector (such as a photodiode) for measuring power of the optical signal and a second photodetector (such as a photodiode) for measuring power of the extracted portion of said looped signal;

a processing unit for determining OSNR of the optical signal based at least on readings of the first and the second photodetectors (i.e. at least on the measured power of said optical signal and of said extracted looped signal).

The back reflected signal may actually be considered to constitute a Stokes signal produced, in response to the optical signal, in the non-linear optical medium owing to the effect of so-called stimulated scattering, being either Brillouin scattering (SBS) or Raman scattering (SRS). The Stokes signal, as any reflected signal, propagates in the direction opposite to the direction of the mentioned optical signal whenever fed into the non-linear optical medium.

The loop, besides the mentioned non-linear optical medium, comprises at least a feedback section which may be a regular optical fiber the loop also comprises a feedback section for returning the back-reflected signal to the non-linear optical medium. The non-linear medium and the feedback section may be interconnected using two optical circulators.

In the proposed monitor, the optical fiber loop preferably comprises two optical circulators switched between the non-linear medium and the feedback section.

Preferably, the monitor comprises means (such as one or more variable optical amplifiers, VOA) for regulating power of the optical signal.

The amplification of the back reflected (Stokes) signal in the loop can be controlled by controlling the insertion loss of the feedback section, for example by changing a splitting ratio X of the optical splitter and/or by adding a variable optical amplifier (VOA) into the feedback section to regulate power of the back-reflected signal.

The monitoring apparatus can be modified to monitor OSNR of several wavelengths (channels) simultaneously or successively (intermittently), thereby to provide the required service information to several respective clients. Such an implementation will be illustrated in, and described with reference to FIG. 10.

In the preferred embodiment, the monitor also comprises an amplifier to amplify the optical signal to a desired/suitable amount of power to be launched to the optical element. That power can also be automatically registered and controllable by the processing unit.

It should be noted that the proposed OSNR monitor has proven as highly sensitive in monitoring OSNR of high bit rate optical signals (40 Gbps and higher), with channel spacing of 100 GHz, 50 GHz or less and for various modulation formats. However, the highly sensitive monitor can also be successfully used at low bit rates and at such conditions where other prior art techniques are ineffective: for example at 2.5 Gbps, 10 Gbps, 20 Gbps, but for very small channel spacing like for example 25 GHz or 12.5 GHz.

The applicable modulation formats are, for example, OOK (On-Off Keying), [D]PSK ([Differential] phase shift keying), [D]QPSK ([Differential] Quaternary Phase Shift Keying), Self Homodyne (SH) QPSK, OFDM (Orthogonal Frequency Division multiplexing), QAM (Quadrature Amplitude Modulation), DuoBinary, SSB (Single Side Band) modulations. Both NRZ and RZ optical line coding of the above modulations formats are applicable, as well as the Dual Polarization version of these modulation formats.

The proposed monitor may be provided with means for intentionally adding an artificial carrier tone (“quasi carrier”) to carrierless modulated signal, thereby reducing the SBS or SRS threshold of the optical signal in the non-linear medium, and with a minor OSNR penalty. This enables to lower the required launched optical power of the signal in the OSNR monitor.

In one preferred embodiment, the monitor comprises a source of a controllable noise signal, so that said optical signal becomes a controllable combined optical signal. The proposed monitor does not require adding the noise signal, but if added, the noise signal allows enhancing the OSNR sensitivity.

According to a second aspect of the invention, there is proposed a method for monitoring OSNR of an optical data being carried in an optical network link, the method comprising:

obtaining an optical signal from said link for monitoring;

introducing said optical signal into an optical loop comprising a non-linear optical medium being capable of producing a back reflected signal to said optical signal, so as to cause circulation of only said back reflected signal in the loop;

extracting a portion of the looped reflected signal from said optical fiber loop;

measuring power of said optical signal (to be introduced in the loop), and measuring power of the extracted portion of the looped back reflected signal;

determining OSNR of the optical signal by processing at least the measured power of said optical signal and power of said extracted portion of the looped reflected signal.

Also, the technique preferably allows amplifying the optical signal to a desired amount of power before introducing it to the loop. The reflected signal (above the SBS or SRS threshold) can actually be considered to comprise only the Stokes signal generated by the non-linear optical medium. Actually, the reflected signal comprises the Stokes and a so-called Rayleigh signal but only the Stokes signal is useful to determine the OSNR. The Rayleigh signal can be seen as a disturbing signal that does not provide any information for deriving the OSNR, since it can be considered as an offset or a constant. Its value is predominant before (below) the SBS threshold but negligible after (above) the SBS threshold.

In practice, some measurement/calculation inaccuracies which may exist in the power launched (scattered) into the nonlinear media, and of the Stokes signal output power could lead to some errors in the estimation of the OSNR.

Therefore, it will be preferred to perform the method at two or more different levels of the launched signal power. The required OSNR level will be obtained as an average of the different estimated OSNR values provided by the two or more different levels of power of the launched optical signal.

The above method allows increasing sensitivity when monitoring OSNR of optical signals in real modern optical networks. For example, it enables highly sensitive and inexpensive monitoring of OSNR at conditions which are impossible for other prior art techniques, such as:

at high bit rates not lower than 40 Gbps, carried in a WDM network having channel spacing 100GHz and smaller;

at low bit rates, for example 2.5 Gbps, 10 Gbps, 20 Gbps, but for very small channel spacing like for example 25 GHz or 12.5 GHz.

It should be noted that the proposed “loop” technique can actually work for high and low bit rates, whatever the channel spacing is.

In practice, the method may comprise:

selecting a specific optical channel to be monitored;

setting and measuring power of the optical signal of the specific optical channel to the desired power to be launched to the loop, according to a desired OSNR range;

setting feedback loss level in the loop according to the desired OSNR range; measuring output power of the loop;

determining OSNR of the optical signal based on the set and measured values.

As mentioned, the method may further comprise adding a quasi carrier to the optical signal having a carrier-less modulation format, at least for a time period required for measuring/determining OSNR.

The described method may be utilized for measuring OSNR of multiple optical channels. Determining of OSNR for a number of optical channels may be performed either successively or simultaneously (in parallel), but always per specific channel.

According to yet a further aspect of the invention, there is provided a software product comprising computer implementable instructions and/or data, which, being stored on an appropriate, non-transitory computer storage media, enables implementation of operations of the above method, when being run on a computer/processor (a processing block).

The software product is preferably accommodated in the processor; it should be provided with information on the currently applied modulation format, say from an operator or from a management system; the processor should also be fed with information about power values of relevant required signals from suitable measuring/monitoring circuits.

The invention will be explained in more details as the description proceeds.

### BRIEF DESCRIPTION OF THE DRAWINGS

The invention will be further described and illustrated with reference to the following non-limiting drawings, in which:

FIG. 1a (prior art) illustrates a known set-up of OSNR measurement based on the SBS (Brillouin scattering) effect in a highly nonlinear fiber.

FIG. 1b (prior art) illustrates a prior art set-up for measuring OSNR of a real optical signal carried by an optical link.

FIG. 2 schematically illustrates the presently proposed SBS-based OSNR monitor for monitoring optical signals obtained from an optical network link; the inventive OSNR monitor comprises a fiber ring cavity (fiber loop) for generating the Stokes wave and a processing unit for determining the OSNR.

FIGS. 3A and 3B shows the performances difference in terms of SBS threshold/power dynamics between the open loop operation (the prior art case) and the proposed, closed fiber loop operation

FIG. 4A shows the optical spectrum of 10 Gbps NRZ On-Off Keying (OOK) signal in a case of 50 GHz channel spacing network.

FIG. 4B shows exemplary results of a numerical simulation of the fiber ring laser output power as a function of the OSNR for 10.7 Gbps NRZ OOK signal for several levels of the launched optical signal, in the case of 50 GHz channel spacing.

FIGS. 4C, 4D, 4E and 4F show how the OSNR monitoring sensitivity changes as a function of the signal launched power, in different OSNR monitoring ranges, for 10.7 Gbps NRZ OOK signal with 50 GHz channel spacing.

FIG. 5A shows optical spectrum of another, 224 Gbps polarization multiplexed (PM)-OFDM signal consisting of 128 16-QAM carriers, in a case of 50 GHz channel spacing network.

FIG. 5B shows exemplary results of a numerical simulation of the fiber ring laser output power as a function of the OSNR for the 224 Gbps PM-OFDM signal (FIG. 5A), for several levels of the launched optical signal, and in the case of 50 GHz channel spacing.

FIGS. 5C, 5D, 5E and 5F show exemplary changes in the OSNR monitoring sensitivity as a function of the signal launched power, for different OSNR monitoring ranges, for the same 224 Gbps PM-OFDM signal with 50 GHz channel spacing.

FIG. 6A schematically illustrates an apparatus for adding a controllable level of optical carrier tone (“an artificial carrier”) to conventional polarization multiplexed carrier-less modulation format, in order to utilize the proposed technique for carrier-less modulation formats.

FIG. 6B schematically illustrates an apparatus for adding a controllable level of optical carrier tone (“artificial carrier”) to conventional single polarization carrier-less modulation format, in order to utilize the proposed technique for carrier-less modulation formats.

FIG. 7 shows an exemplary graph of the OSNR penalty induced by adding the artificial carrier, as a function of the Optical Signal to Carrier Ratio (OSCR) level.

FIG. 8A shows the optical spectrum of 126.5 Gbps PM-QPSK signal (originally carrier-less, but comprising an artificially added carrier), in a case of 50 GHz channel spacing network.

FIG. 8B shows exemplary results of a numerical simulation of the fiber ring laser output power as a function of the OSNR for 126.5 Gbps PM-QPSK signal (see FIG. 8A) for several levels of the launched optical signal, in the case of 50 GHz channel spacing.

FIGS. 8C, 8D, 8E and 8F show exemplary changes in the OSNR monitoring sensitivity as a function of the signal launched power for different OSNR monitoring ranges, for the same 126.5 Gbps PM-QPSK signal with 50 GHz channel spacing.

FIG. 9A shows the optical spectrum of 44.6 Gbps DQPSK signal comprising an artificial carrier, in a case of 50 GHz channel spacing network.

FIG. 9B shows exemplary results of a numerical simulation of the fiber ring laser output power as a function of the OSNR for the above 44.6 Gbps DQPSK signal, for several levels of the launched optical signal, in the case of 50 GHz channel spacing.

FIGS. 9C, 10D, 10E and 10F show exemplary changes in the OSNR monitoring sensitivity as a function of the signal launched power for different OSNR monitoring ranges, for the same 44.6 Gbps DQPSK signal with 50 GHz channel spacing.

FIG. 10 schematically illustrates an embodiment of the proposed monitor, being an SBS-based OSNR monitor adapted for simultaneously monitoring a number of WDM optical signals obtained from an optical network link.

### DETAILED DESCRIPTION OF THE PREFERRED EMBODIMENTS

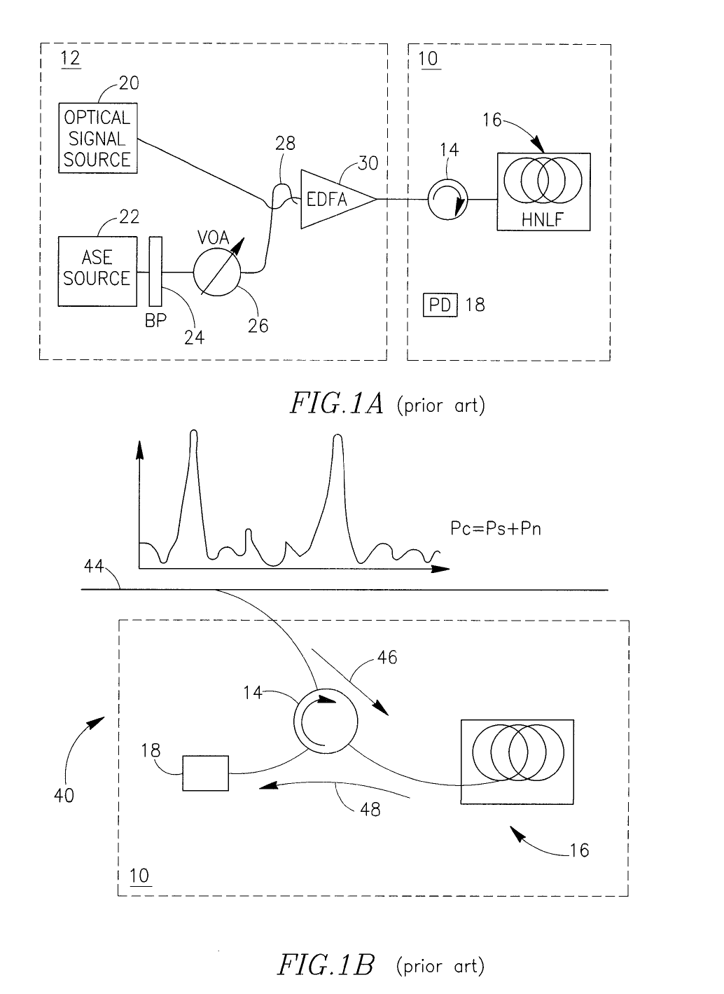

FIG. 1a (prior art) schematically illustrates how the ASE noise, being always present within a real optical signal, can be presented as a noise source 22 which introduces a variable value of noise to a pure optical signal produced by an optical signal source 20. The resulting optical signal is then fed to an SBS based OSNR monitor 10. FIG. 1a illustrates the principle of the SBS-based noise monitoring. It should be noted that the character of the Stimulated Brillouin Scattering of an optical signal reacts to presence of in-band noise in the signal.

FIG. 1b (prior art) illustrates a prior art arrangement 40 for true OSNR measurement of a real optical signal, based on the SBS effect. The optical signal 42 comprising its in band noise is transmitted via an optical network link 44 and is tapped there-from to the SBS based OSNR monitor 10.

A power fraction of the optical signal 42 (say, comprising one exemplary channel to be monitored) from the link 44 exhibits a composite power, noted P, which is composed from the signal power, noted Ps and the in band noise power, noted Pₙ. The signal composite power (P_{c}=Pₛ+Pₙ) is amplified (not shown) and launched into a medium 16 creating the enhanced SBS effect. This medium can be a highly nonlinear fiber (HNLF) or crystal or nonlinear planar integrated waveguide. The signal is sent into the nonlinear SBS medium with a known fixed optical power. When the signal's OSNR is high, the launched power is sufficiently high above the SBS threshold to lead to a significant SBS induced back-reflected power which is measured using an optical circulator 14 and a photo diode 18. For the same given launched power, when the signal OSNR is low, the amount of in band noise power reduces the power of the signal spectral components, which leads to a reduction of the SBS induced reflected power. The change in the back-reflected power is used to identify the OSNR of the signal being monitored.

However, due to the accepted design requirements to modern optical networks, the requested OSNR for 40 Gbps to 100 Gbps optical signal must be equal or better than 15 dB, which means that optical signals must have very low noise. Therefore, the in band noise power will be not high enough to produce significant changes in the SBS induced back-reflected power, especially for DWM system with 50 GHz channel spacing. This leads to a significant reduction of the OSNR monitoring sensitivity.

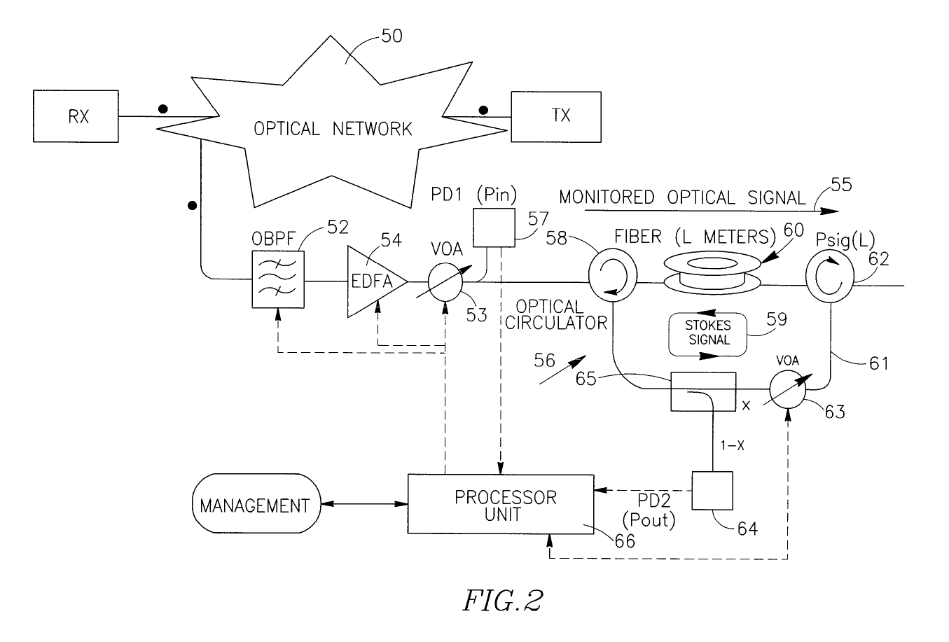

Any practical implementation of the above-described set-up in real deployed optical networks is limited to low or medium bit rates (up to 10 Gbps). Relatively good sensitivity in the OSNR measurements for 40 Gbps NRZ OOK, mentioned in WO 2008/151384, could be obtained only due to quite a wide bandwidth filter (1 nm bandpass filter). In real networks, where the optical filter bandwidth is limited to 80 GHz (for 100 GHz channel spacing), the described set-up is non-satisfying. In order to improve the OSNR monitoring sensitivity, to adapt the technique to real conditions in modern optical networks and to various modulation formats of the signal, the Inventors propose a new OSNR monitor shown in FIG. 2.

In FIG. 2, a power fraction of the optical signal to be monitored is extracted from the network (like in FIG. 1b) by a tap and an optical filter in order to reject all but one DWDM optical channels.

A tap (not shown) derives a power fraction of the optical WDM signals from a network 50, and an optical filter 52 (preferably, a tunable filter) enables to select the signal to be monitored. The selected signal exhibits a composite power, noted P_{c} composed by the signal power, noted Ps and the in band noise power, noted Pₙ. The optical signal is then amplified by an amplifier 54 (optionally, also regulated by a variable optical attenuator VOA 53) and launched into a non-linear optical medium—in our example, an SBS creating non-linear fiber 60. It should be kept in mind that an SBS or SRS effect can be stimulated using other media than the fiber, it can be also stimulated by other nonlinear photonic waveguides. Such media may form part of a fiber loop 56 for creating the enhanced back scattering effect.

The optical signal (its direction is shown by arrow 55) is sent into the fiber loop 56 via an optical circulator 58 with a known fixed optical composite power which can be measured by a photodiode PD1 (57). The nonlinear SBS medium 56 generates and repeatedly amplifies a Stokes signal generated by the SBS process which back propagates in the SBS medium (i.e., in the direction 59 opposite to the incoming signal 55). In order to loop, enhance and amplify the Stokes signal created in the SBS process, the fiber section 60 via an optical circulator 62 is connected to a feedback fiber section 61 and reinserted to the SBS medium 60 via the first optical circulator 58. In view of the above, a fiber ring (loop) is created for the Stokes signal only, which undergoes multiple round trips in the SBS medium 60, enhancing its optical power. It should be noted that contrary to the Stokes signal, the optical signal incoming the fiber 60 from the side of amplifier 54 makes just a single path 55 in the SBS medium 60 owing to the configuration of the optical circulators 58, 62.

It should also be noticed that such a configuration enables the creation of a lasering process for the Stokes signal, seeded (initiated) by the optical signal extracted from the network 50. This lasering process enhances the SBS threshold of the SBS medium drastically in comparison to the case where no feedback is performed for the Stokes signal. This low SBS threshold enables to reduce drastically the length of the SBS medium and the optical launched power required for the signal to stimulate the SBS process.

The OSNR monitoring sensitivity is strongly improved by using the loop. The loop does not only lower the SBS threshold, but also enables generation of a lasering signal at the Stoke's wave, which enhances dynamics of the system and therefore the sensitivity of the OSNR.

For controlling power of the looped back reflected /scattered signal, an optional VOA 63 may be added in the loop in FIG. 2.

The optical power of the Stokes signal is measured using a photodiode PD2 (64), upon extracting, by an optical power splitter 65, a fraction of the Stokes signal's power in the feedback fiber section. The loss level of the feedback fiber section 61 will be noted R and is determined by the insertion loss of the Stokes signal in the circulators, the loss of the optical power splitter and the loss of the feedback fiber. This loss level of the feedback fiber section can be variable by making the power splitter 65 variable or/and by inserting a VOA (variable optical attenuator 63) in the feedback fiber section 61.

The feedback loss is defined (in dB units) as:

R[dB]IL_{circulator1}+IL_{circulator2}+IL_{feedbackfiber}+ILₛₚₗᵢₜₜₑᵣ+IL_{VOA} (Eq. 1)

where ILₛₚₗᵢₜₜₑᵣ=10 log₁₀(1/X), with X is the split out power fraction of the Stokes wave, being fed back to the SBS medium. Note that the prior art solution (not comprising the loop), will be indicated later in the description as X=0.

The OSNR of the optical signal is then derived by a processing block 66 from the measurements performed by photodiodes 57 and 64 (for the Optical launched signal power and the Stokes signal power, respectively), according to the optical modulation type of the signal, the knowledge of the feedback loss level, the characteristics of the SBS medium (loss, SBS gain, length), and optionally some other parameters.

The steady state equations governing the optical power of the Signal and Stokes signals/waves (P_{sig} and P_{Stokes} respectively) in the nonlinear fiber (said SBS medium) are as follows [R. B. Jenkins, R. M. Soya and R. I. Joseph, “Steady state noise analysis of spontaneous and stimulated Brillouin scattering in optical fibers”, J. of Lightwave Technol., vol 25, no 3, pp. 763-765, 2007]:

$$\begin{matrix}\{ \begin{matrix}\frac{d {P}_{sig}}{d z} = - α {P}_{sig} - \frac{{g}_{B}}{{KA}_{eff}} {P}_{sig} {P}_{Stokes} - B \sqrt{\frac{{g}_{B}}{K} {P}_{sig} {P}_{Stokes}} \\ \frac{d {P}_{Stokes}}{d z} = α {P}_{Stokes} - \frac{{g}_{B}}{{KA}_{eff}} {P}_{sig} {P}_{Stokes} - B \sqrt{\frac{{g}_{B}}{K} {P}_{sig} {P}_{Stokes}}\end{matrix} & ( Eq . 2 )\end{matrix}$$

Where:

a and g_{B} are the attenuation and the Brillouin gain coefficients of the nonlinear fiber, respectively,

A_{eff} is the effective mode area of the nonlinear fiber,

K is the polarization factor taking into account possible polarization mismatch between the signal and Stokes waves (K=1 for parallel polarization, K=∞ for orthogonal polarization), and

B refers to the noise coefficient of the spontaneous Brillouin scattering.

When measuring the optical power in the feedback section, it should be noted that besides the Stokes power, so-called back Rayleigh scattering of the signal exists in the nonlinear fiber. The Rayleigh signal can be seen as a disturbing signal that does not provide any information for deriving the OSNR. It can be considered as an offset or a constant. Its value is predominant before (below) the SBS threshold but negligible after (above) the SBS threshold.

The equation governing the back Rayleigh scattering of the signal is:

$$\frac{d {P}_{Rayleigh}}{d z} = α {P}_{Rayleigh} - {α}_{R} {P}_{Sig} \qquad ( Eq . 3 )$$

Where α_{R}, is the Back-Rayleigh coefficient of the nonlinear fiber.

Assuming in a nonlinear fiber with length L in an open loop configuration (corresponding to prior art cases), no feedback is performed for the Stokes signal (R=∞) [Eq.1], therefore Eq.2 and Eq.3 must be solved using the following boundary conditions:

$$\{ \begin{matrix}{P}_{sig} ( 0 ) = {P}_{0} \\ {P}_{Stokes} ( L ) = 0 \\ {P}_{Rayleigh} ( L ) = 0\end{matrix} \qquad ( Eq . 4 )$$

Where P₀ corresponds to the optical input power of the spectral component of the optical signal, leading to initiation of the SBS process in the nonlinear fiber.

In a closed loop configuration (corresponding to the present apparatus), the feedback is performed for the Stokes signal and for the back-Rayleigh scattering of the signal with a feedback loss R, therefore Eq.2 and 3 must be solved using the following boundary conditions:

$$\{ \begin{matrix}{P}_{sig} ( 0 ) = {P}_{0} \\ {P}_{Stokes} ( L ) = \frac{{P}_{Stokes} ( 0 )}{R} \\ {P}_{Rayleigh} ( L ) = \frac{{P}_{Raleigh} ( 0 )}{R}\end{matrix} \qquad ( Eq . 5 )$$

The tap photodiode PD1 with an associated VOA are placed after the optical amplifier (say, EDFA), in order to control and indicate to the processor 72 the optical power launched into the SBS enhanced medium.

The photo diode PD2 (64) measures the output power, Pₒᵤₜ of the fiber ring lasering signal composed by the Stokes wave and the Back-Rayleigh scattering of the signal wave, (Pₒᵤₜ=P_{Stokes}+P_{Rayleigh}). Based on it, and based on the launched power measured by the photodiode PD1 (57), the processor unit 66 using its internal lookup/calibration tables and data on the current modulation format, is able to determine the OSNR according to the lookup table of the output power as a function of the launched optical power and the modulation format. Preferably, the processor 66 also takes into account the feedback loss level R and the SBS medium parameters (length, loss, SBS gain).

For making decisions based on the measurements of the two photo diodes 57 and 64, the processor unit 66 may be provided with necessary data from management. As mentioned, such data may relate to possible modulation formats and the current modulation format, to the current path of the signal, possibly to an estimated OSNR. Using the above data and calibration tables previously introduced in the processor unit 66, the unit is able to set the mentioned VOAs 53, 63, to adjust the EDFA (54) and to determine OSNR of the optical signal.

The proposed technique, owing to feeding the Stokes signal back into the nonlinear SBS medium, drastically decreases the SBS threshold. and leads to a lasering effect of the SBS stokes wave. (The decreased SBS threshold means that in order to obtain a given level of the Stokes signal power, the required power level of the input signal may be lower than in the case of open loop.) All this enables to drastically reduce the length of the SBS medium (to just a few meters using the adequate SBS medium) and the required power to be launched into the SBS medium. Such reduction of the SBS medium length (preferably, of the nonlinear fiber length) enables reducing the environmental (temperature or stress) dependence of the SBS process. Furthermore, the short fiber length reduces the impact of fiber birefringence and therefore the polarization dependence of the SBS process, thus enhancing the SBS efficiency.

In addition, an interesting consequence of the SBS process is that the State Of Polarization (SOP) of the signal wave attracts the SOP of the Stokes wave leading to a maximum efficiency of the SBS amplification. In order to maintain the SOP of the Stokes wave while passing the feedback section, it is preferable to use one or more polarization maintaining components in the feedback section, such as polarization maintaining circulator(s) 58, 62, the fiber 61, VOA 63, and/or splitter 65.

The sensitivity (the OSNR monitoring range) of the proposed monitor can be controlled by optimizing the feedback loss (which can be regulated by the proportion of energy split out by the splitter 65 from the loop, and/or by inserting a VOA 63 in the feedback section) and the launched power level, and offers an ability to tune the OSNR monitoring sensitivity according to the desired OSNR range of search.

By using the proposed new monitor, the determining of the in band OSNR of an optical signal can be done by the following steps:
1) Selecting the channel to be monitored (for example, by means of the tunable optical filter 52 shown in FIG. 2). The management can also provide information such as the signal modulation format;
2) Setting the amplifier output power (by EDFA 54, VOA 53) to the desired power to be launched to the SBS medium 60;
3) Setting the feedback loss level (say, by controlling the splitting ratio of the splitter 65 or by controlling the attenuation level of a VOA 63 located in the feedback section) according to a desired OSNR range of search and possibly by using calibration tables;
4) Measuring the output power by the second photodiode (64);
5) Evaluating the OSNR of the optical signal power by the processing unit 66,

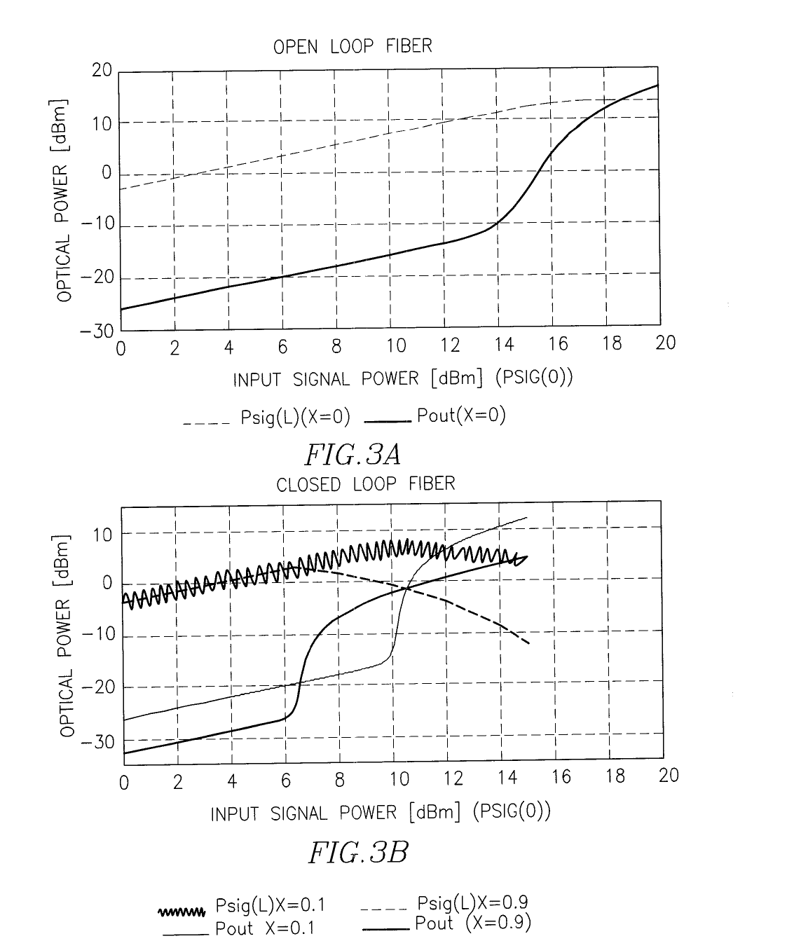

FIGS. 3A and 3B show an example illustrating the dependence of the output power, Pout (Stokes+Rayleigh) (measured at PD2 64) and signal output power P_{sig}(L) at the output of the SBS medium as function of the signal input power (Psig(0)) by solving numerically Eq.2 and Eq.3. It is assumed that the SBS medium is a 3 meter long Chalcogenide fiber and the input signal power is a pure Continuous Wave (CW) signal. The parameters of the Chalcogenide fibers used are:

| B | A_{eff} | g_{B} | α_{R} | α |
|---|---|---|---|---|
| 22.535 [1/√m] | 39 um² | 6.2 10⁻⁹ m/W | 0.008 dB/m | 0.8 dB/m |

FIG. 3A shows an example the case where there is no feedback (X=0 and R=∞) of the Stokes wave. In this case (corresponding to the prior art apparatus), the SBS threshold occurs around 14 dBm. Below the threshold, the Pout is dominated by the Rayleigh back scattering of the signal while above the SBS threshold the Stokes wave power.

FIG. 3B shows the case where there is feedback of the Stokes wave with X=0.1 and X=0.9. The feedback enhances the amplification of the Stokes waves and leads to a lasering process. SBS threshold is reduced (in comparison to the open loop case) and depends on the loss of the fiber cavity. For X=0.9 the threshold (can be seen as a sharp change of slope of the curve) is at 6.4 dBm only, while for X=0.1 it is increased to 10.2 dBm due to the higher fiber cavity loss. In the closed loop case, the output power exhibits large transition of 15 dB for 1 dB variation of the input power around the threshold, while in the open loop case, transition of 15 dB for Pout occurs for 2.2 dB variation of the input power around the threshold. This fact declares that the closed loop configuration exhibits higher sensitivity of the input signal power variation that the open loop case. Therefore, the use of a Brillouin fiber ring laser (i.e., the non-linear fiber loop) instead of an open loop Brillouin fiber enhances the OSNR monitoring sensitivity drastically.

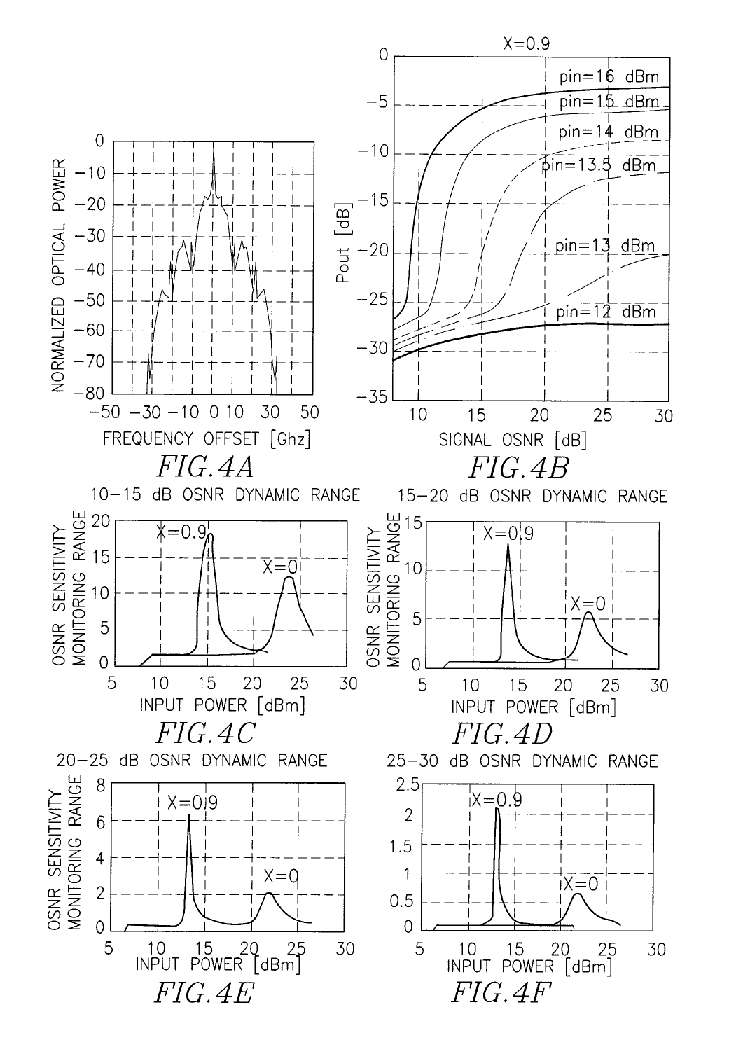

FIG. 4A shows the optical spectrum of a 10 Gbps NRZ On-Off Keying (OOK) signal in a case of 50 GHz channel spacing network, assuming the 0 dBm average optical power. The optical carrier of the signal is clearly shown in the central portion of the spectrum and is the main contributor of the SBS effect.

FIG. 4B shows a group of graphs being numerical simulation results of the output power from the Brillouin Fiber Ring Laser as a function of the OSNR of the optical signal. (In case of a fiber based loop it is commonly defined as a fiber ring laser.) The graphs of FIG. 4B are built for 10.7 Gbps NRZ OOK signal in a 50 GHz channel spacing network, and for different values of power launched into the Fiber Ring.

The simulation assumes that the SBS enhanced media is a 3 m-long Chalcogenide fiber and the power splitting ratio X of 0.9 leading to a ring cavity loss of 4.85 dB.

Since the SBS effect is an undesired effect in optical networks, the optical carrier of 10G signals is usually dithered in order to increase the SBS threshold by more than 5 dB. When increasing the OSNR, the fiber ring laser output power increases. For the launched power below 12 dBm, the carrier spectral component of the optical signal (as seen in FIG. 4A) does not reach the SBS threshold, leading to a monotonic and slow increase of the fiber ring output power with the OSNR. When the signal launched power increases, the stimulated Brillouin scattering threshold is reached, resulting in a drastic increase of the fiber ring laser output power while increasing the sensitivity to the signal OSNR. For a launched power of 15 dBm, variations of more than 15 dB of the output power are provided for OSNR variation from 10 to 15 dB.

FIGS. 4C-4F show how the sensitivity monitoring range of the OSNR monitor varies as a function of the signal input power in the case of X=0.9 (the proposed exemplary proportion of power, for returning to the loop) and X=0 (the prior art case). The figure illustrates graphs for 4 OSNR sub-ranges (0-15 dBm, 15-20 dB 20-25 dB and 25-30 dB) and for 10.7 Gbps NRZ OOK signal in the 50 GHz channel spacing configuration. For the present apparatus, the maximum OSNR sensitivity range is obtained for launched power between 13 and 15.3 dBm for the different OSNR sub-ranges while for the prior art case (X=0) the maximum OSNR range is more reduced and obtained for higher input power varying from 21.9 to 23.8 dBm. A summary of the optimum results is given in the Calibration table below

| X = 0.9 | | X = 0 (prior art) | | |
|---|---|---|---|---|
| | OSNR | | OSNR | |
| Input power | sensitivity | Input power | sensitivity | |
| [dBm] | range [dB] | [dBm] | range [dB] | OSNR range |
| 15.3 | 18.3 | 23.8 | 12.3 | 10 dB-15 dB |
| 13.8 | 12.5 | 22.5 | 5.6 | 15 dB-20 dB |
| 13.2 | 6.3 | 22 | 2 | 20 dB-25 dB |
| 13 | 2.2 | 21.9 | 0.65 | 25 dB-30 dB |

The processor may store optional calibration table(s) for X=0.8, X=0.75, etc.

The above simulations show that high power of the signal can be obtained, so they prove that using a short, 3 m-long Chalcogenide fiber in the proposed nonlinear loop allows measuring OSNR with high accuracy.

Management may “suggest” to the processor a working point in the calibration table. Using the working point, the processor may regulate VOAs 53, 63 of the input signal and of the back reflected looped signal.

In one example of selecting a working point, let us suppose that the signal to be monitored is a 10.7 Gbps NRZ OOK signal with an OSNR level of 22 dB (which is “not known to the apparatus” in advance). If the management has not provided an estimated OSNR level of the signal in order to select the optimum OSNR range, the monitoring system can find the optimum monitoring sensitivity range and the most accurate estimation of the OSNR level as following:

1. The default OSNR range (10-15 dB) is selected by setting the input power to the nonlinear medium to be 15.3 dBm.

2. Since the signal real OSNR is 22 dB, the measured output power will be found to be −5 dBm according to FIG. 4C. If the photodetector accuracy is +/−0.2 dB, this means that the signal OSNR is estimated to be between 20.7 dB and 24 dB.

3. Since the estimated OSNR is outside the selected optimal OSNR range (10-15 dB), the better OSNR sensitivity range must be selected. According to the estimated measured OSNR level range, the 20-25 dB OSNR sensitivity range will be selected by setting the input power to be 13.2 dB.

4. The measured output power is found to be −19.7 dBm which corresponds to an estimated OSNR level between 21.9 dB and 22.1 dB, assuming the photodetector accuracy is +/−0.2 dB.

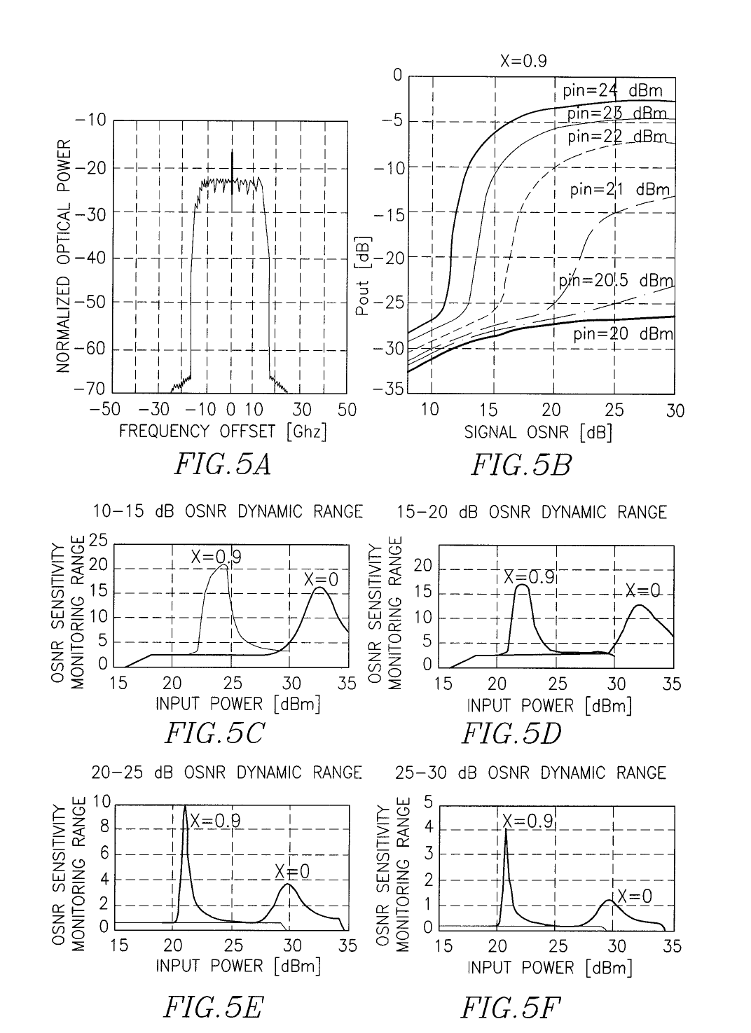

FIG. 5A shows the optical spectrum of a 224 Gbps PM-OFDM signal in a case of 50 GHz channel spacing network, assuming the 0 dBm average optical power. The OFDM signal is composed by 128 subcarriers. The central subcarrier remains unmodulated, some subcarriers are used as tone carrier tones while the modulated carriers use 16-QAM modulation scheme. The optical carrier of the signal is clearly shown in the center of the spectrum and is the main contributor of the SBS effect.

FIG. 5B shows a group of graphs being numerical simulation results of the output power from the Brillouin Fiber Ring Laser as a function of the OSNR of the optical signal. The graphs of FIG. 5B are built for the 224 Gbps PM-OFDM signal in a 50 GHz channel spacing network, and for different values of power launched into the Fiber Ring. The simulation assumes that the SBS enhanced media is a 3 m-long Chalcogenide fiber and the power splitting ratio X is of 0.9, leading to a ring cavity loss of 4.85 dB.

When increasing the OSNR, the fiber ring laser output power increases. For the launched power below 20 dBm, the carrier spectral component of the optical signal (as seen in FIG. 5A) does not reach the SBS threshold, leading to a monotonic and slow increase of the fiber ring output power with the OSNR. When power of the launched signal increases, the stimulated Brillouin scattering is enhanced, leading to a drastic increase of the fiber ring laser output power while increasing the sensitivity to the signal OSNR. For the launched power of 22 dBm, variations of more 15 dB of the output power are provided for the OSNR variations between 15 to 20 dB.

FIG. 5C-5F shows how the sensitivity monitoring range of the OSNR monitor varies as a function of the signal input power in the case of X=0.9 and X=0 (prior art case) when the input signal is the 224 Gbps PM-OFDM signal in the 50 GHz channel spacing configuration. As previously, the figure illustrates graphs for the 4 OSNR sub-ranges (0-15 dBm, 15-20 dB 20-25 dB and 25-30 dB). For the present apparatus, the maximum OSNR sensitivity range is obtained for launched power between 20.7 and 24.3 dBm for the different OSNR sub-ranges while for the prior art case (X=0) the maximum OSNR range is more reduced and obtained for much higher input powers varying from 29.5 to 32.6 dBm. The summary of the optimum results is given in the table below.

| X = 0.9 | | X = 0 (prior art) | | |
|---|---|---|---|---|
| | OSNR | | OSNR | |
| Input power | sensitivity | Input power | sensitivity | |
| [dBm] | range [dB] | [dBm] | range [dB] | OSNR range |
| 24.3 | 20.6 | 32.6 | 16.2 | 10 dB-15 dB |
| 22.1 | 16.1 | 30.7 | 9.2 | 15 dB-20 dB |
| 21.1 | 9.8 | 29.8 | 3.7 | 20 dB-25 dB |
| 20.7 | 4 | 29.5 | 1.2 | 25 dB-30 dB |

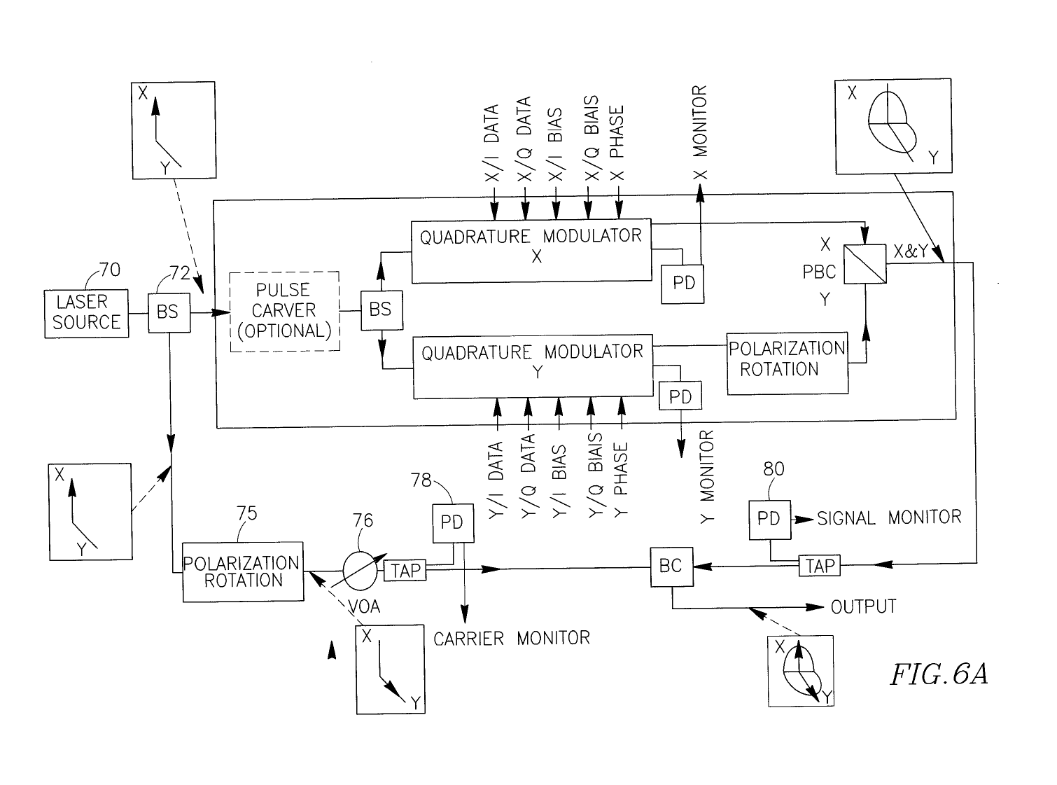

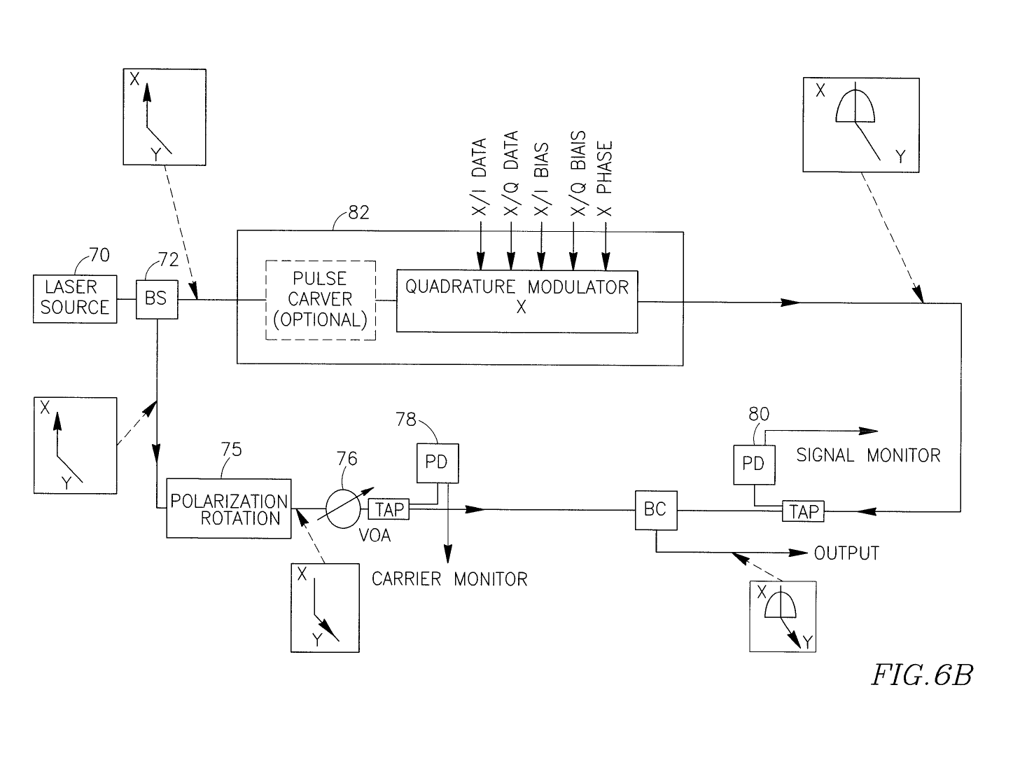

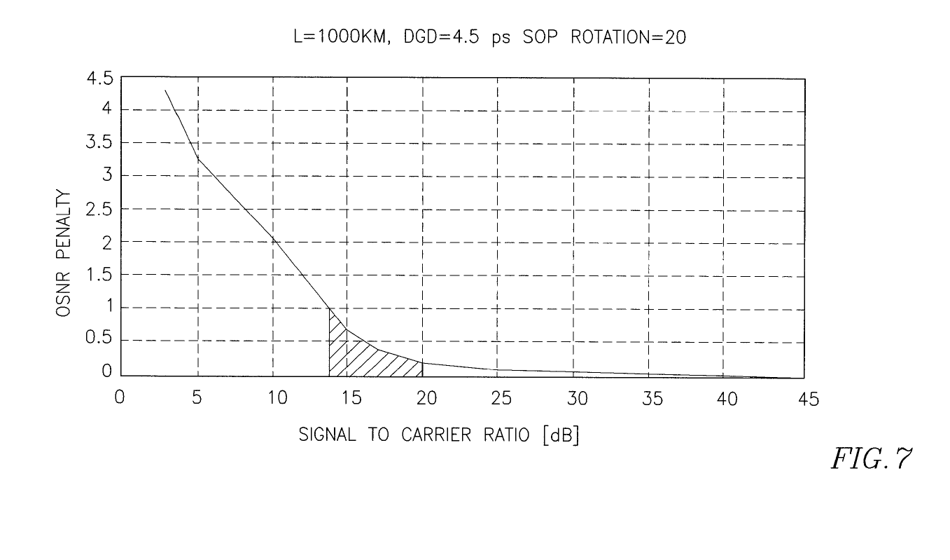

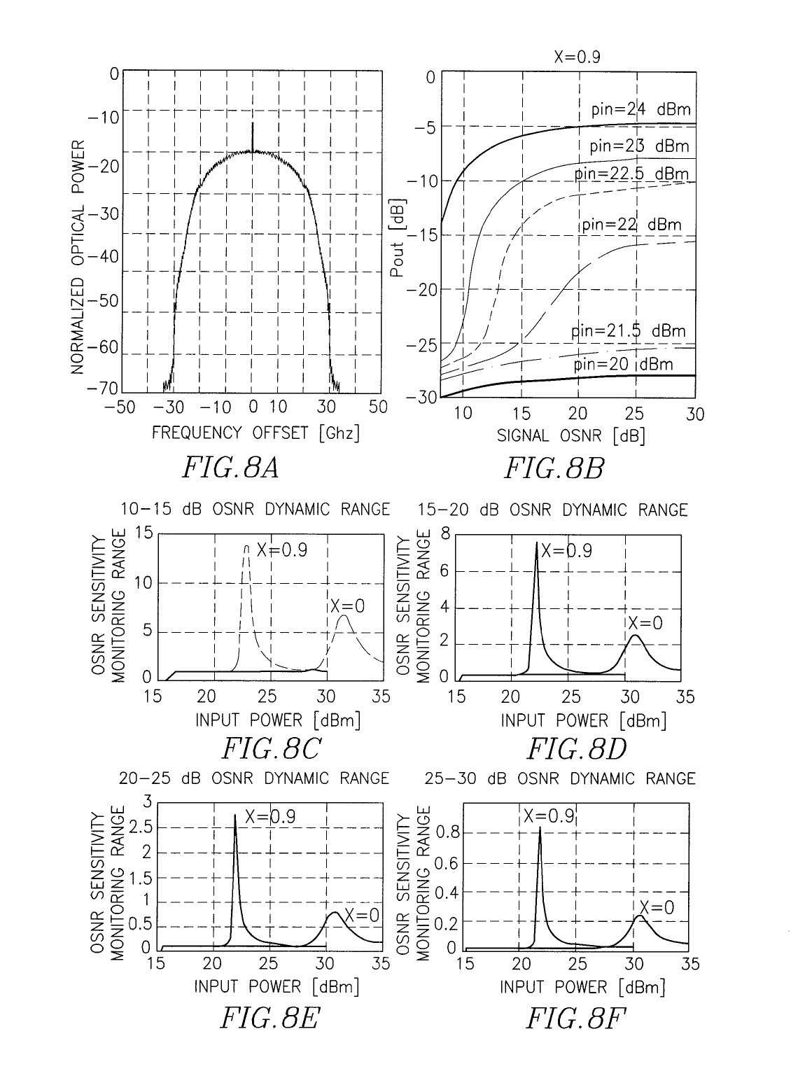

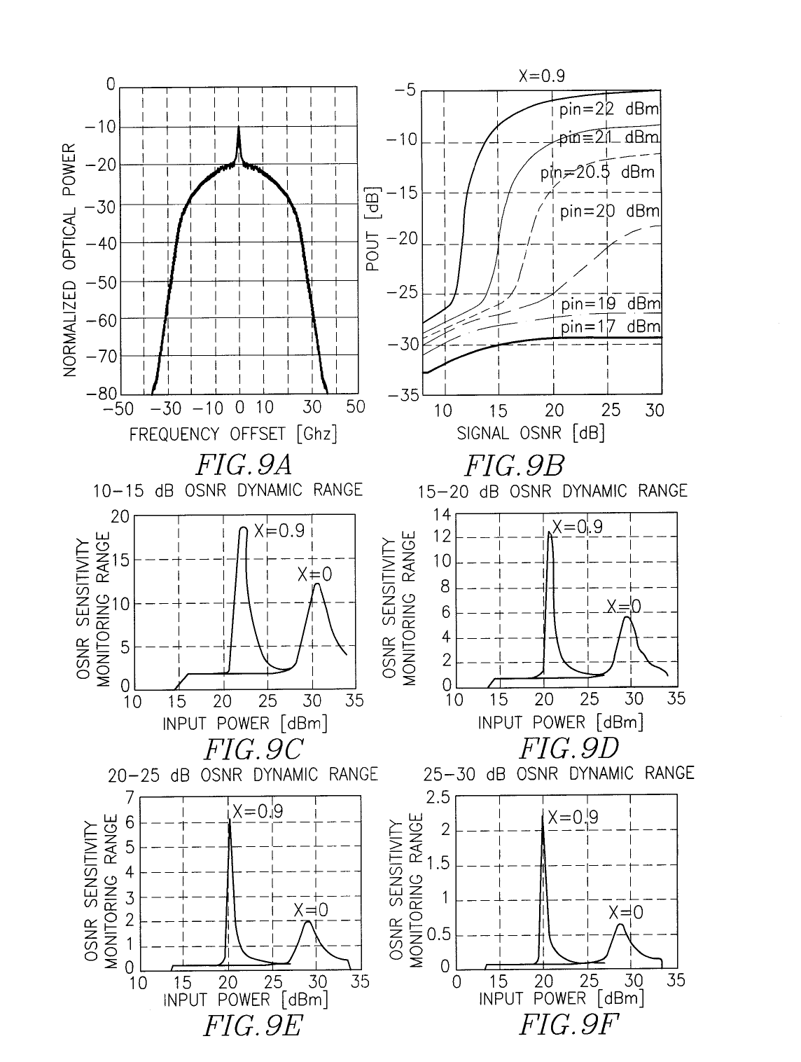

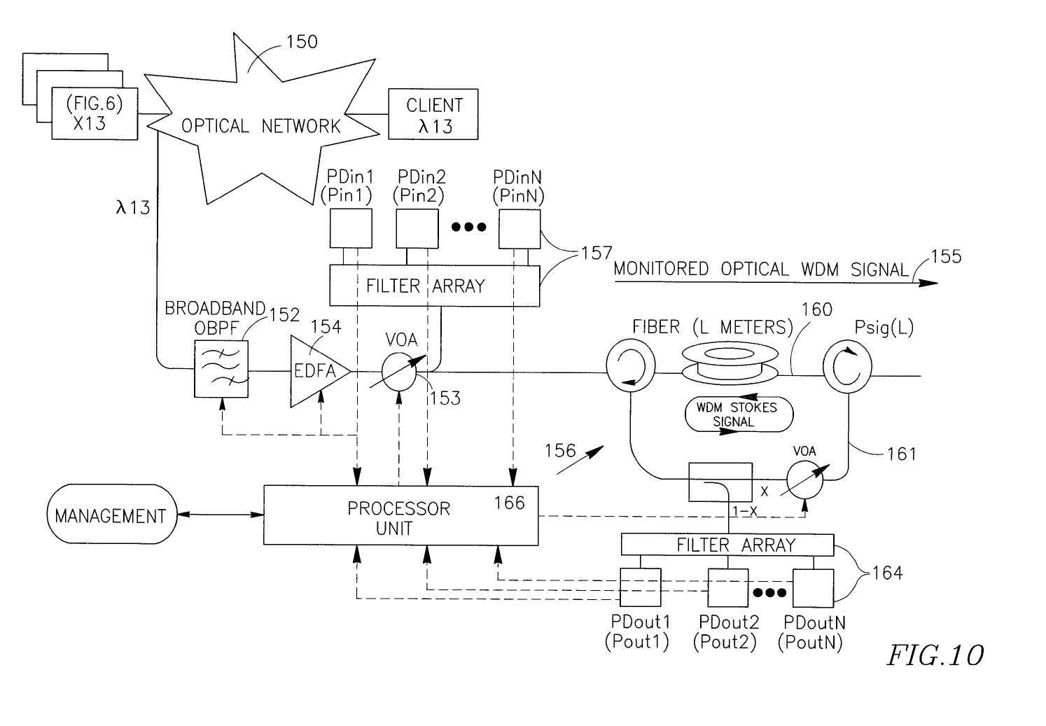

Carrier-less modulation formats such as BPSK, DPSK, (D)QPSK, PM-QPSK present a low SBS threshold leading to a very high required optical launched power (>30 dBm for a 3 meter long Chalcogenide fiber). In order to reduce the required launched power, it is possible to insert a small power fraction of the optical carrier to the modulated signal as shown in FIG. 6A for the case of polarization multiplexed carrier-less modulation format and in FIG. 6B the case of single polarization carrier-less modulation format.

In FIG. 6A, a laser source 70 is connected to a power beam splitter (BS) 72 which splits the optical continuous wave (CW) beam into two optical CW beams. A first CW laser beam is sent to a conventional polarization multiplexed IQ optical modulator 74, while the second CW beam (the optical carrier) is sent to a power regulator (such as variable optical attenuator 76). The state of polarization of the optical carrier is controlled by a polarization rotator or controller 75. It can be set either to 0 degree (X polarization) or 90 degrees (Y polarization) or 45 degree (X+Y polarization). The output power of the modulated optical beam (said optical signal) is monitored via a tap photo-detector 80, and the measured power can be denoted Psig at the 80. The output power of the optical carrier after the optical power regulator is monitored via a tap photo-detector 78 and the measured optical power in the 78 is denoted P_{carrier}. By measuring and regulating both Psig and Pcarrier, it is possible to measure and determine the Optical Signal to Carrier Ratio (OSCR). BC 77 stands for beam combiner, which combines the carrier and the signal, so that the output signal actually comprises the carrier which has been added artificially, after the signal has been polarization multiplexed.

In FIG. 6B, a laser source 70 is connected to a power beam splitter (BS) 72 which splits the optical continuous wave (CW) beam into two optical CW beams. A first CW beam is sent to a conventional single polarization IQ optical modulator 82 (in this case the IQ modulator is for single polarization), while the second CW beam (the optical carrier) is sent to a power regulator (such as a variable optical attenuator 76). The state of polarization of the optical carrier is rotated by 90 degrees in order to get the orthogonal SOP of the modulated optical beam. The output power of the modulated optical beam (said optical signal) is monitored via a tap photo-detector, and its measured power is denoted Psig. The output power of the optical carrier after the optical power regulator is monitored via a tap photo-detector 78 and the measured optical power in the 78 is denoted P_{carrier}. By measuring and regulating both Psig and Pcarrier, it is possible to measure and determine the Optical Signal to Carrier Ratio (OSCR).

It should be noted that for modulation formats which do not comprise a carrier, the described modulator may be used for artificially adding to them a so-called quasi carrier (by adding a signal 75 before VOA 76), which then may be back scattered in the optical non-linear medium of the proposed inventive loop-comprising OSNR monitor. Therefore, by adding the quasi-carrier to carrierless modulation formats, such formats become suitable for monitoring their OSNR by the proposed monitor and method; the required launched power will be higher in order to measure the OSNR.

It should also be emphasized, that the proposed procedure of adding quasi carrier to an optical signal of a specific optical channel may be performed intermittently, just during short periods of time intended for monitoring OSNR, in order not to affect the normal operation in the network.

FIG. 7 shows an example of the OSNR penalty induced as a function of the OSCR for a 126.5 Gbps PM-QPSK signal, to which an artificial carrier has been added. The OSNR penalty is calculated in reference to the required OSNR in back to back performances (i.e., performances without added network impairments). The OSNR penalty is numerically calculated for a BER of 2×10⁻², in the case of 1000 km transmission link without dispersion compensation, assuming a Differential Group Delay (DGD) value of 4.5 ps, 20 degree rotation mismatch of the signal polarization tributaries in reference to the principal states of polarization in the coherent receiver and 2 GHz frequency mismatch between the signal and local oscillator frequencies.

The OSNR penalty is calculated in reference to the required OSNR in back to back performances. Adding optical carrier o carrier-less modulated signal can lead to an OSNR penalty. The aim of this graph is to demonstrate that a precise amount of carrier must be chosen in order not to penalize the system performance but high enough in order to decrease the SBS threshold of the signal in the OSNR monitor.

As shown in FIG. 7, the OSNR penalty is high for low OSCR and decreases when increasing OSCR. For an OSCR level of 16 dB, the OSNR penalty is reduced to 0.5 dB only and such OSCR level provides a high enough optical carrier to decrease the SBS threshold of the signal below 25 dBm in the OSNR monitor.

A careful tradeoff should be found between a low OSCR level which enables to reduce significantly the SBS threshold of the signal but leads a significant OSNR penalty and a high OSCR level which does not lead to a significant OSNR penalty but dos not improve significantly the SBS threshold.

A suggested OSCR range for 126.5 Gbps PM-QPSK is the range betwen 14 dB-20 dB which guarantees the OSNR penalty lower than 1 dB.

For an OSCR level of 16 dB, the OSNR penalty is reduced to 0.5 dB only and such OSCR level provides a high enough optical carrier to decrease the SBS threshold of the signal below 25 dBm in the OSNR monitor.

FIG. 8A shows the optical spectrum of 126.5 Gbps PM-QPSK signal with a determined value of the optical carrier's power, artificially added to the carrier-less signal, in a case of 50 GHz channel spacing network, assuming the 0 dBm average optical power. The signal exhibits an OSCR of 16 dB leading to an optical carrier peak, higher by 7 dB than the PM QPSK signal higher spectral components.

FIG. 8B shows a group of graphs being numerical simulation results of the output power from the Brillouin Fiber Ring Laser (56) as a function of the OSNR of the optical signal. The graphs of FIG. 8B are built for 126.5 Gbps PM-QPSK signal with OSCR of 16 dB in a 50 GHz channel spacing network, and for different values of power launched into the Fiber Ring. The simulation assumes that the SBS enhanced media is a 3 m-long Chalcogenide fiber and the power splitting ratio X of 0.9 leading to a ring cavity loss of 4.85 dB.

When increasing the OSNR, the fiber ring laser output power increases. For the launched power below 21.5 dBm, the carrier spectral component of the optical signal (as seen in FIG. 8A) does not reach the SBS threshold, leading to a monotonic and slow increase of the fiber ring output power with the OSNR. When the launched signal's power increases, the stimulated Brillouin scattering is enhanced resulting in a drastic increase of the fiber ring laser output power while increasing the sensitivity to the signal OSNR. For a launched power of 22 dBm, variations of more than 7 dB of the output power is provided for OSNR variation from 15 to 20 dB.

The parameters of the curve 22 dBm may be therefore recommended as a working point for the processing unit when the signal OSNR is in the range of 15-20 dB, for the signal OSNR between 15-20 dB. For other OSNR ranges it might not be the case.

FIGS. 8C-8F show how the sensitivity monitoring range of the OSNR monitor varies as a function of the signal input power in the case of X=0.9 (the proposed loop-based monitor) and X=0 (prior art case) when the input signal is 126.5 Gbps PM-QPSK with OSCR level of 16 dB in the 50 GHz channel spacing configuration. The figures respectively illustrate graphs for the 4 OSNR sub-ranges (0-15 dBm, 15-20 dB 20-25 dB and 25-30 dB). For the present apparatus, the maximum OSNR sensitivity range is obtained for the launched power between 21.8 and 22.8 dBm for the different OSNR sub-ranges, while in the prior art case (X=0) the maximum OSNR range is more reduced and obtained for a much higher input power varying from 30.6 to 31.5 dBm. The summary of the optimum results is given in the table below.

| X = 0.9 | | X = 0 (prior art) | | |
|---|---|---|---|---|
| | OSNR | | OSNR | |
| Input power | sensitivity | Input power | sensitivity | |
| [dBm] | range [dB] | [dBm] | range [dB] | OSNR range |
| 22.8 | 13.8 | 31.5 | 6.7 | 10 dB-15 dB |
| 22 | 7.4 | 30.9 | 2.5 | 15 dB-20 dB |
| 21.9 | 2.7 | 30.7 | 0.8 | 20 dB-25 dB |
| 21.8 | 0.8 | 30.6 | 0.25 | 25 dB-30 dB |

Would the carrier not be added artificially, the required input power would be more than 30 dBm.

FIG. 9A shows the optical spectrum of 44.6 Gbps RZ-DQPSK signal with a determined value of the artificially added optical carrier, in a case of 50 GHz channel spacing network, assuming 0 dBm average optical power. The signal exhibits an OSCR of 13 dB leading to an optical carrier peak higher by 8 dB than the RZ-DQPSK signal higher spectral components.

FIG. 9B shows a group of graphs being numerical simulation results of the output power from the Brillouin Fiber Ring Laser (56) as a function of the OSNR of the optical signal. The graphs of FIG. 9B are built for 44.6 Gbps RZ-DQPSK signal with OSCR of 13 dB in a 50 GHz channel spacing network, and for different values of power launched into the Fiber Ring. The simulation assumes that the SBS enhanced media is a 3 m-long Chalcogenide fiber and the power splitting ratio X of 0.9 leading to a ring cavity loss of 4.85 dB.

When increasing the OSNR, the fiber ring laser output power increases. For launched power below 19 dBm, the carrier spectral component of the optical signal (as seen in FIG. 8A) does not reach the SBS threshold, leading to a monotonic and slow increase of the fiber ring output power with the OSNR. When the launched signal's power increases, the stimulated Brillouin scattering is enhanced resulting in a drastic increase of the fiber ring laser output power while increasing the sensitivity to the signal OSNR. For a launched power of 21 dBm, variations of more than 11 dB of the output power is provided for OSNR variation from 15 to 20 dB.

FIGS. 9C-9F show how the sensitivity monitoring range of the OSNR monitor varies as a function of the signal input power in the case of X=0.9 (the proposed loop-based monitor) and X=0 (prior art case) when the input signal is 44.6 Gbps RZ-DQPSK with OSCR level of 13 dB in the 50 GHz channel spacing configuration. The figures respectively illustrate graphs for the 4 OSNR sub-ranges (0-15 dBm, 15-20 dB 20-25 dB and 25-30 dB). For the present apparatus, the maximum OSNR sensitivity range is obtained for the launched power between 20 and 22.2 dBm for the different OSNR sub-ranges, while in the prior art case (X=0) the maximum OSNR range is more reduced and obtained for a much higher input power varying from 28.8 to 30.7 dBm. The summary of the optimum results is given in the table below.

| X = 0.9 | | X = 0 (prior art) | | |
|---|---|---|---|---|
| | OSNR | | OSNR | |
| Input power | sensitivity | Input power | sensitivity | |
| [dBm] | range [dB] | [dBm] | range [dB] | OSNR range |
| 22.2 | 18.3 | 30.7 | 12.3 | 10 dB-15 dB |
| 20.7 | 12.5 | 29.4 | 5.6 | 15 dB-20 dB |
| 20.2 | 6.1 | 29 | 2 | 20 dB-25 dB |
| 20 | 2.2 | 28.8 | 0.65 | 25 dB-30 dB |

For all examples described above, it can be noticed that the OSNR sensitivity range is the largest for low OSNR ranges. Therefore it can be suggested to add an artificial noise signal (as proposed in the Applicant's patent application WO10150241A, incorporated herein by reference), in order to improve the OSNR sensitivity when measuring signals with high OSNR ranges (>15 dB).

FIG. 10 describes one embodiment of the system for simultaneous/intermittent monitoring of multiple WDM optical channels. This is particularly important when measuring the OSNR of a multi band OFDM channel or when measuring the OSNR of several independent WDM channels.

Simultaneous monitoring of WDM signals would be a key advantage in optical networks since it may improve the monitoring latency and lower the monitoring cost. However, this should be done without compromising the monitoring sensitivity, and with a negligible interchannel crosstalk impact.

Indeed, each WDM signal generates its own back propagating Stokes signal independently and each Stokes signal power provides the information on the OSNR level of its corresponding monitored optical signal. However, sending several WDM signals into the nonlinear medium can enhance other nonlinear effects besides the SBS effect. Nonlinear Kerr effect induced nonlinear interaction such as Self phase modulation (SPM), Cross Phase Modulation (XPM) and Four Wave Mixing (FWM) may affect the optical signal spectra and therefore the efficiency of the SBS effect. Such drawbacks have been reported in the prior art, for example in [M. D Pelusi, A. Flu and B. J. Eggleton, “Multi-channel in band OSNR monitoring using Stimulated Brillouin Scattering,” Optics Express. Vol. 18, No 9, pp. 9435-9446, 2010].

However, the concept proposed in the present patent application can also be extended to multi channel in band OSNR monitoring since it presents the very advantage of not being affected by the Kerr effect nonlinear channel interactions. Indeed, the reduced launched signal power combined with the reduced length of the nonlinear medium and the fact that the monitored WDM signal only passes through the nonlinear media once leads to the very negligible impact of the Kerr effect.

Still, there are other solutions for monitoring multiple optical channels using the proposed concept.

FIG. 10 illustrates an example of an SBS-based in band OSNR monitoring apparatus adapted for monitoring (simultaneously) several WDM optical signals obtained from an optical network link. Blocks analogous to blocks of FIG. 2 are marked with similar numerals by adding “1” before the numeral. Different WDM optical signals may be launched to the optical network 150 from a number of circuits similar to that shown in FIG. 6A or FIG. 6B.

The multi-channel OSNR monitor of FIG. 10 comprises a fiber ring loop 156 for generating several Stokes waves (each one corresponding to one of the WDM optical channel) and a processing unit 166 for determining the OSNR. The differences in comparison with the apparatus illustrated in FIG. 2 are the following:

The OBPF filter 152 is broad enough in order to select several WDM signals. After the amplifier 154 and the VOA 153, the launched power of each WDM channel is measured; it is made by extracting a portion of the amplified WDM signals by a tap and by sending them to a filter array combined with a photodetectors array (together marked as 157). The filter array can be a demultiplexer filter or an array of tunable filters.

When propagating into the nonlinear SBS medium, each WDM channel generates its own Stokes signal which circulates in the fiber loop 156. The optical power of the WDM Stokes waves is measured, upon extracting a fraction of the Stokes signal's power by an optical power splitter from the feedback fiber section 161. This fraction of the WDM Stokes's signal is then sent to a filter array combined with photodetector arrays (164).

Since cross-talk between WDM signals in the loop is critical for measuring OSNR, it is highly desired to reduce power of each specific channel. This can be done only in the “loop” technique, since only the back reflected signal is looped. In comparison with the prior art technique of “open loop”, the power of the signal which should be launched to the non-linear medium can be significantly reduced and the OSNR sensitivity and accuracy will be preserved and even increased.

While the proposed technique (the monitor, the method and the software product) have been described with reference to specific examples, it should be appreciated that other versions of the method may be proposed and other implementations of the monitor may be built, which should be considered part of the invention whenever protected by the claims which follow.

1. A monitor for monitoring OSNR of data being carried via an optical network link, the monitor comprising:
means for obtaining an optical signal from said link;
a loop comprising a non-linear optical medium being capable of producing a back reflected signal to said optical signal, the loop being adapted to loop said back reflected signal;
a device for extracting a portion of the looped back reflected signal from said loop;
a first photodetector for measuring power of the optical signal and a second photodetector for measuring power of the extracted portion of said looped signal; and
a processing unit for determining OSNR of the optical signal based at least on readings of the first and the second photodetectors.

2. The monitor according to claim 1, wherein
the back reflected signal is produced, in response to the optical signal, in the non-linear optical medium owing to either Stimulated Brillouin scattering (SBS) or Stimulated Raman scattering (SRS) effect; and
the loop also comprises a feedback section for returning the back-reflected signal to the non-linear optical medium.

3. The monitor according to claim 1, adapted for controlling the back-reflected signal in the loop by controlling insertion loss of the feedback section and/or power of the back-reflected signal.

4. The monitor according to claim 1, further comprising a source of controllable noise signal for enhancing the OSNR sensitivity.

5. The monitor according to claim 1, further provided with means for intentionally adding an artificial carrier tone to a carrier-less modulated signal, for reducing SBS or SRS threshold of the optical signal in the nonlinear medium.

6. The monitor according to claim 1, adapted for monitoring several WDM channels simultaneously or successively.

7. A method for monitoring OSNR of an optical data being carried in an optical network link, the method comprising:
obtaining an optical signal from said link for monitoring;
introducing said optical signal into an optical loop comprising a non-linear optical medium being capable of producing a back reflected signal to said optical signal, so as to cause circulation of only said back reflected signal in the loop;
extracting a portion of the looped reflected signal from said optical fiber loop;
measuring power of said optical signal;
measuring power of the extracted portion of the looped back reflected signal; and
determining OSNR of the optical signal by processing at least the measured power of said optical signal and power of said extracted portion of the looped reflected signal.

8. The method according to claim 7, further comprising:
selecting a specific optical channel to be monitored;
setting and measuring power of the optical signal of the specific optical channel to the desired power to be launched to said loop according to a desired OSNR range;
setting feedback loss level in the loop according to the desired OSNR range;
measuring output power of the back reflected signal in said loop; and
determining OSNR of the optical signal based on the set and the measured values.

9. The method according to claim 7, further comprising adding a quasi carrier to the optical signal having a carrierless modulation format, at least for a time period for determining OSNR.

10. A software product comprising computer implementable instructions and/or data, stored on an appropriate non-transitory computer storage media and enabling implementation of steps of the method according to claim 8, when being run on a computer. 5
